(19) United States
(12) Patent Application Publication
(10) Pub. No.: US 2015/0220629 A1
(43) Pub. Date: Aug. 6, 2015

(54) Sound Melody as Web Search Query

(71) Applicant: Darren Nolf, Reed City, MI (US)

(72) Inventor: Darren Nolf, Reed City, MI (US)

(21) Appl. No.: 14/611,609

(22) Filed: Feb. 2, 2015

Related U.S. Application Data
(60) Provisional application No. 61/933,903, filed on Jan. 31, 2014.

(51) Int. Cl. G06F 17/30; G10L 15/26; G10L 15/08; G10H 1/00

(52) U.S. Cl. CPC G06F 17/30705; G10H 1/0008; G10L 15/26; G10L 15/08; G10H 2210/056

(57) ABSTRACT

An Internet search infrastructure features searches from a sound melody. The user may capture a melody or sing a known portion of the melody, and record it with the mobile application. The infrastructure employs melody recognition and voice-to-text software to analyze and recognize a melody which has been captured from a smartphone or tablet, then searches the Internet for text or data containing the portion of the lyrics or melody which was captured. The search infrastructure is controlled from a mobile application installed in a tablet or smartphone.

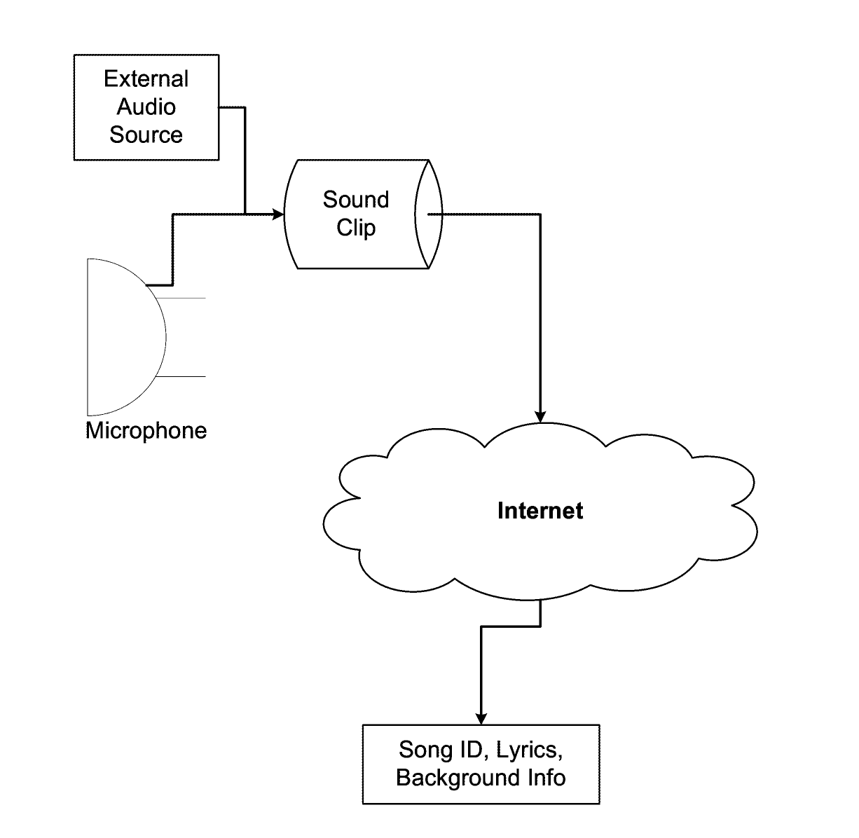

### CROSS-REFERENCE TO RELATED APPLICATIONS

This application claims the benefit of U.S. Provisional Application No. 61/933,903, filed Jan. 31, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to Internet search infrastructure and in particular to an Internet search from a sound melody. The proliferation of audio data files in the MPEG-1 (MP3) format has opened a new world of data analysis and filing, based on the song titles, album titles, performers, melodies, and lyrics of the world of music. But the problem of identifying a song based on a few words of the lyrics, or a few bars of the melody, is still a challenge. Data collections such as Wikipedia™ and YouTube™ provide an enormous wealth of searchable data. Acquiring the title of a song, or the name of performer or band, based on nothing more than a few bars of a melody presents a substantial challenge. Fortunately, software is now available which will recognize such melodies. An Internet search infrastructure in the form of a mobile application, which provides melody recognition and voice-to-text software to analyze captured melodies from a smartphone or tablet, turns the data into a textual search and then searches the Internet for similar lyrics and melodies, would resolve this problem.

### SUMMARY OF THE INVENTION

Accordingly, the invention is directed to Internet search infrastructure which searches from a sound melody. The user may capture a melody or sing a known portion of the melody, and record it with the mobile application. The infrastructure employs melody recognition and voice-to-text software to analyze and recognize a melody which has been captured from a smartphone or tablet, then searches the Internet for text or data containing the portion of the lyrics or melody which was captured. The search infrastructure is controlled from a mobile application installed in a tablet or smartphone.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrate one embodiment of the invention and, together with the description, serves to explain the principles of the invention.

The FIGURE is a system diagram displaying the electronic system components, features, communications, and their interconnections, and other relevant processes and events during the course of using the invention.

### DETAILED DESCRIPTION OF THE INVENTION

Referring now to the invention in more detail, the invention is directed to Internet search infrastructure which searches from a sound melody. The user may capture a melody or sing a known portion of the melody, and record it with the mobile application. The infrastructure employs melody recognition and voice-to-text software to analyze and recognize a melody which has been captured from a smartphone or tablet, then searches the Internet for text or data containing the portion of the lyrics or melody which was captured. The search infrastructure is controlled from a mobile application installed in a tablet or smartphone (generically, a mobile computing device).

Components of the first exemplary embodiment include the user's tablet or smartphone; a mobile application; and an Internet website. The mobile application may be used to select and capture a portion of a melody, whether it is sung by the user or previously recorded. The search function then identifies salient characteristics of the captured melody, using melody recognition software and voice-to-text software, and correlates the captured melody with other melodies on the Internet sharing the same salient characteristics, and with images and text which share elements of the captured melody; the salient characteristics may, but need not be programmatically defined, and may be generated or learned through applicable well-known recognition algorithms. Optionally, the search function may rely upon voice-to-text analysis exclusively, or upon melody characteristics exclusively, or any combination of these or other characteristics. The search results may include the title of the song, the titles of any albums containing the song, the performers and bands (generically, artists) who performed, recorded, or wrote (generically, produced) the song, the complete lyrics of the song, and any background information which may be available. The search results may also include links to digital copies of the song which may be obtained and played, such as a YouTube music video or an iTunes® selection.

The user is preferably able to record up to about fifteen seconds of the song portion or pause streaming music, such as a satellite radio broadcast or podcast, and record a portion of the music being played to enable the most accurate result. Generically, a sound clip is generated either from a sound source, typically either the device microphone or from any external source, including local audio files as well as broadcasts via satellite, Internet, or terrestrial radio. The system then analyzes the recorded portion and either presents the salient characteristics to a search engine as a search query, or consults a melody recognition database provided by the website, thereby converting the image into a textual or data search query. The search includes data services such as Wikipedia™, and music video hosting services such as YouTube™. The search function then delivers search result pages to the user via the visual display of a user's electronic device, such as a tablet or smartphone. Foreign language selections are also preferably searchable. The system also preferably features the ability to narrow the search by adjourning the partial lyric simultaneously in the mix of the rhythm provided to enable more accurate results.

To use the first exemplary embodiment, the user downloads and installs the related mobile application on the user's mobile electronic device, such as a tablet or smartphone. The user then activates the application, and may select and capture a portion of a melody being played, or sing and record a known portion of the melody. The user may use the application to pause streaming audio to conduct the search. The application analyzes the captured melody for salient characteristics and conducts an Internet search. The search result pages may be displayed as a pop-up dialog box on the visual display of the user's electronic device.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A method for performing an internet search from a sound melody comprising a method of operating a mobile computing device:
(a) obtaining a sound clip from a sound source;
(b) generating a search query based on at least one of the group of performing voice-to-text analysis on said sound clip or identifying the salient characteristics of a melody contained within said sound clip;
(c) searching the internet using said search query; and
(d) returning, as search results including information relating to any of the group of the title of a song contained in said sound clip, the titles of albums containing the song contained in said sound clip, the artists who produced the song contained in said sound clip, the lyrics of the song contained in said sound clip, background information relating to the song contained in said sound clip, recordings of the song contained in said sound clip, or media relating to the song contained in said sound clip.

2. The method for performing an internet search from a sound melody of claim 1 wherein said search query is generated exclusively by performing voice-to-text analysis.

3. The method for per performing an internet search from a sound melody of claim 1 wherein said search query is generated by performing voice-to-text analysis in combination with identifying the salient characteristics of said melody.

4. The method for per performing an internet search from a sound melody of claim 1 wherein performing voice-to-text analysis is enabled for one or more foreign languages.

5. The method for per performing an internet search from a sound melody of claim 2 wherein performing voice-to-text analysis is enabled for one or more foreign languages.

6. The method for per performing an internet search from a sound melody of claim 3 wherein performing voice-to-text analysis is enabled for one or more foreign languages.

7. The method for per performing an internet search from a sound melody of claim 1 wherein said sound source is selected from the group of a microphone, a local audio file, a satellite broadcast, an internet broadcast, or a terrestrial radio broadcast.

8. The method for per performing an internet search from a sound melody of claim 2 wherein said sound source is selected from the group of a microphone, a local audio file, a satellite broadcast, an internet broadcast, or a terrestrial radio broadcast.

9. The method for per performing an internet search from a sound melody of claim 3 wherein said sound source is selected from the group of a microphone, a local audio file, a satellite broadcast, an internet broadcast, or a terrestrial radio broadcast.

10. The method for per performing an internet search from a sound melody of claim 4 wherein said sound source is selected from the group of a microphone, a local audio file, a satellite broadcast, an internet broadcast, or a terrestrial radio broadcast.

11. The method for per performing an internet search from a sound melody of claim 5 wherein said sound source is selected from the group of a microphone, a local audio file, a satellite broadcast, an internet broadcast, or a terrestrial radio broadcast.

12. The method for per performing an internet search from a sound melody of claim 6 wherein said sound source is selected from the group of a microphone, a local audio file, a satellite broadcast, an internet broadcast, or a terrestrial radio broadcast.

13. A computer system, the system comprising a mobile computing device, said mobile computing device being in electronic communication with at least one of the group of a microphone or an external audio source, and said mobile computing device being in electronic communication with the internet; said mobile computing device being configured for:
(a) obtaining a sound clip from a sound source;
(b) generating a search query based on at least one of the group of performing voice-to-text analysis on said sound clip or identifying the salient characteristics of a melody contained within said sound clip;
(c) searching the internet using said search query; and
(d) returning, as search results including information relating to any of the group of the title of a song contained in said sound clip, the titles of albums containing the song contained in said sound clip, the artists who produced the song contained in said sound clip, the lyrics of the song contained in said sound clip, background information relating to the song contained in said sound clip, recordings of the song contained in said sound clip, or media relating to the song contained in said sound clip.

14. The computer system of claim 13 wherein said search query is generated exclusively by performing voice-to-text analysis.

15. The computer system of claim 13 wherein said search query is generated by performing voice-to-text analysis in combination with identifying the salient characteristics of said melody.

16. The computer system of claim 13 wherein said search query is generated by performing voice-to-text analysis in combination with identifying the salient characteristics of said melody.

17. A computer program product, said computer program product being embodied in a tangible non-transitory computer readable storage medium and comprising computer instructions for:
(a) obtaining a sound clip from a sound source;
(b) generating a search query based on at least one of the group of performing voice-to-text analysis on said sound clip or identifying the salient characteristics of a melody contained within said sound clip;
(c) searching the internet using said search query; and
(d) returning, as search results including information relating to any of the group of the title of a song contained in said sound clip, the titles of albums containing the song contained in said sound clip, the artists who produced the song contained in said sound clip, the lyrics of the song contained in said sound clip, background information relating to the song contained in said sound clip, recordings of the song contained in said sound clip, or media relating to the song contained in said sound clip.

18. The computer program product of claim 17 wherein said search query is generated exclusively by performing voice-to-text analysis.

19. The computer program product of claim 17 wherein said search query is generated by performing voice-to-text analysis in combination with identifying the salient characteristics of said melody.

20. The computer system of claim 17 wherein said search query is generated by performing voice-to-text analysis in combination with identifying the salient characteristics of said melody.
